(19) United States
(12) Patent Application Publication
(10) Pub. No.: US 2020/0128188 A1
(43) Pub. Date: Apr. 23, 2020

(54) IMAGE PICKUP DEVICE AND IMAGE PICKUP SYSTEM

(71) Applicant: NIKON CORPORATION, Tokyo (JP)

(72) Inventors: Hiroyuki IWASAKI, Yokohama-shi (JP); Ikuya SAITO, Kawasaki-shi (JP); Masao NAKAJIMA, Kawasaki-shi (JP)

(73) Assignee: NIKON CORPORATION, Tokyo (JP)

(21) Appl. No.: 16/333,630

(22) PCT Filed: Sep. 28, 2017
(86) PCT No.: PCT/JP2017/035161

§ 371 Date: Jun. 7, 2019

(30) Foreign Application Priority Data
Sep. 30, 2016 (JP) 2016-194628

(51) Int. Cl. H04N 5/232; H04N 7/18

(52) U.S. Cl. CPC H04N 5/23296; H04N 7/181; H04N 5/23299

(57) ABSTRACT

An image-capturing device includes: a first image-capturing unit and a second image-capturing unit, each of the first image-capturing unit and the second image-capturing unit having a plurality of lenses and a plurality of light-receiving units, each lens having a plurality of light-receiving units, the first image-capturing unit and the second image-capturing unit each outputting signals upon receiving light from a subject having transmitted through an image-capturing optical system via the plurality of lenses in the light-receiving units; and a generation unit that generates images of the subject at a plurality of positions in an optical axis direction of the image-capturing optical system, based on a signal outputted from the first image-capturing unit and a signal outputted from the second image-capturing unit.

### TECHNICAL FIELD

The present invention relates to an image-capturing device and an image-capturing system.

### BACKGROUND ART

A camera capable of generating an image focusing on any surface of a subject is known (for example, PTL1). In conventional light field cameras, it is difficult to reduce intervals at which images focusing on any surface can be generated.

### CITATION LIST

### Patent Literature

PTL1: Japanese Laid-Open Patent Publication No. 2015-32948

### SUMMARY OF INVENTION

According to a first aspect, an image-capturing device comprises: a first image-capturing unit and a second image-capturing unit, each of the first image-capturing unit and the second image-capturing unit having a plurality of lenses and a plurality of light-receiving units, each lens having a plurality of light-receiving units, the first image-capturing unit and the second image-capturing unit each outputting signals upon receiving light in the light-receiving units from a subject having transmitted through an image-capturing optical system via the plurality of lenses; and a generation unit that generates images of the subject at a plurality of positions in an optical axis direction of the image-capturing optical system, based on a signal outputted from the first image-capturing unit and a signal outputted from the second image-capturing unit.

According to a second aspect, an image-capturing device comprises: a first image-capturing unit including a plurality of image-capturing units each having an image-capturing optical system through which light from a subject transmits, the first image-capturing unit capturing an image of a subject to output a signal; a second image-capturing unit including a plurality of image-capturing units each having an image-capturing optical system through which light from a subject transmits, the second image-capturing unit capturing an image of a subject to output a signal; and a generation unit that generates an image of a subject at a plurality of positions in an optical axis direction of the image-capturing optical system, based on the signal outputted from the first image-capturing unit and the signal outputted from the second image-capturing unit.

According to a third aspect, an image-capturing system comprises: a first image-capturing device having: a first image-capturing unit having a plurality of lenses and a plurality of light-receiving units, each lens having a plurality of light-receiving units, the first image-capturing unit outputting a signal upon receiving light from a subject having transmitted through an image-capturing optical system in the light-receiving units; a second image-capturing unit having a plurality of lenses and a plurality of light-receiving units, each lens having a plurality of light-receiving units, the second image-capturing unit outputting a signal upon receiving light from a subject having transmitted through an image-capturing optical system in the light-receiving units; and a generation unit that generates images of the subject at a plurality of positions in an optical axis direction of the image-capturing optical system, based on the signal outputted from the first image-capturing unit and the signal outputted from the second image-capturing unit; and a second image-capturing device having: a third image-capturing unit having a plurality of lenses and a plurality of light-receiving units, each lens having a plurality of light-receiving units, the third image-capturing unit outputting a signal upon receiving light from a subject having transmitted through an image-capturing optical system in the light-receiving units; a fourth image-capturing unit having a plurality of lenses and a plurality of light-receiving units, each lens having a plurality of light-receiving units, the fourth image-capturing unit outputting a signal upon receiving light from a subject having transmitted through an image-capturing optical system in the light-receiving units; and a generation unit that generates images of the subject at a plurality of positions in an optical axis direction of the image-capturing optical system, based on the signal outputted from the third image-capturing unit and the signal outputted from the fourth image-capturing unit, wherein: the number of light-receiving units provided for each of the lenses of the first image-capturing unit and the number of light-receiving units provided for each of the lenses of the second image-capturing unit are larger than the number of light-receiving units provided for each of the lenses of the third image-capturing unit and the number of light-receiving units provided for each of the lenses of the fourth image-capturing unit.

According to a fourth aspect, an image-capturing device comprises: a first image-capturing unit having a plurality of lenses and a plurality of light-receiving units, each lens having a plurality of light-receiving units, the first image-capturing unit outputting a signal upon receiving light from a subject having transmitted through an image-capturing optical system via the plurality of lenses in the light-receiving units; a second image-capturing unit having a plurality of light-receiving units and outputting a signal upon receiving light from a subject having transmitted through an image-capturing optical system in the light-receiving units; and a generation unit that generates images of the subject at a plurality of positions in an optical axis direction of the image-capturing optical system, based on the signal outputted from the first image-capturing unit and the signal outputted from the second image-capturing unit.

### BRIEF DESCRIPTION OF DRAWINGS

FIG. 1 is a view schematically showing an image-capturing device.

FIG. 2 is a cross-sectional view schematically showing a light flux from a light point on an image plane to be synthesized and an image-capturing unit.

FIG. 3 is a top view for explaining a ranging process.

FIG. 4 illustrates a first ranging process.

FIG. 5 is a view illustrating the image-capturing device arranged in a parking lot.

FIG. 6 shows examples of an arrangement of the image-capturing units.

FIG. 7 shows examples of an arrangement of the image-capturing units.

FIG. 8 schematically shows a configuration of the image-capturing unit.

FIG. 9 is a view schematically showing an image-capturing device.

FIG. 10 is a plan view schematically showing an example of an arrangement of the image-capturing units.

FIG. 11 shows top views of the image-capturing units.

FIG. 12 is a cross-sectional view schematically showing a light flux from a light point on an image plane to be synthesized and an image-capturing unit.

FIG. 13 is a cross-sectional view schematically showing a light flux from a light point on an image plane to be synthesized and an image-capturing unit.

FIG. 14 is a view for explaining a method of generating image data with two image-capturing units.

### DESCRIPTION OF EMBODIMENTS

### First Embodiment

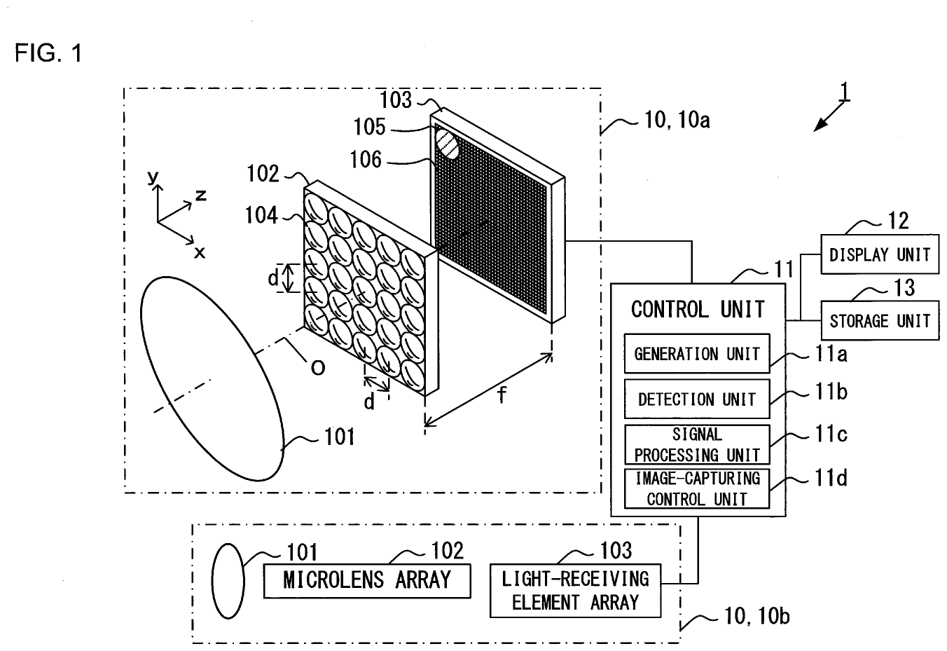

FIG. 1 is a view schematically showing an image-capturing device according to a first embodiment. The image-capturing device 1 according to the first embodiment has a plurality of image-capturing units capable of refocus photographing in which an image focusing on any surface of a subject can be generated after photographing. The image-capturing device 1 generates a refocus image from data captured by one or more image-capturing units. This image-capturing device can be used for a surveillance camera and the like fixedly installed for capturing an image of a specific range to monitor a suspicious individual, for example.

The image-capturing device 1 includes two image-capturing units 10a, 10b, a control unit 11, a display unit 12, and a storage unit 13.

The image-capturing unit 10a includes an image-capturing optical system 101, a microlens array 102, and a light-receiving element array 103. The image-capturing optical system 101 forms a subject image in the vicinity of the microlens array 102. The microlens array 102 has a plurality of microlenses 104 arranged two-dimensionally, and a distance between centers of microlenses adjacent in the x direction and in the y direction is d. The light-receiving element array 103 has a plurality of light-receiving element groups 105 arranged two-dimensionally. Light, which is incident into one microlens 104, is then incident into one light-receiving element group 105. Each light-receiving element group 105 includes a plurality of light-receiving elements 106 arranged two-dimensionally. Note that the microlens array 102 may include the microlenses 104 each having a circular, rectangular, or hexagonal shape. FIG. 1 shows circular microlenses 104, as an example. In the case of using hexagonal microlenses 104, a plurality of microlenses 104 may be arranged in a honeycomb pattern.

An image of the subject is formed in the vicinity of the microlens array 102 by the image-capturing optical system 101. A distance between a light-receiving surface of the light-receiving element array 103 and a principal plane of the microlens 104 substantially coincides with a focal length f of the microlens 104.

The image-capturing unit 10b has the same configuration as that of the image-capturing unit 10a, including an image-capturing optical system 101, a microlens array 102, and a light-receiving element array 103. Note that optical characteristics of the image-capturing optical system 101 of the image-capturing unit 10a and optical characteristics of the image-capturing optical system 101 of the image-capturing unit 10b may be the same or different. Here, the optical characteristics of the image-capturing optical system include a focal length, an aperture value, an angle of view, a F-number, and the like of the image-capturing optical system. For example, the image-capturing optical system 101 of the image-capturing unit 10a may be a telephoto lens having a focal length of 300 mm, and the image-capturing optical system 101 of the image-capturing unit 10b may be a standard lens having a focal length of 50 mm. Alternatively, the image-capturing optical system 101 of the image-capturing unit 10a may be a standard lens having a focal length of 50 mm, and the image-capturing optical system 101 of the image-capturing unit 10b may be a wide-angle lens having a focal length of 24 mm. Alternatively, the image-capturing optical system 101 of the image-capturing unit 10a may be a standard lens having a focal length of 50 mm, and the image-capturing optical system 101 of the image-capturing unit 10b may also be a standard lens having a focal length of 50 mm.

The number of the image-capturing units is not limited to two (10a, 10b), but may be three or more. In that case, optical characteristics of the image-capturing optical system 101 of an image-capturing unit may be different from optical characteristics of image-capturing optical systems 101 of other image-capturing units, or optical characteristics of image-capturing optical systems 101 of all image-capturing units may be different. Furthermore, optical characteristics of image-capturing optical systems 101 of all image-capturing units may be the same.

Note that one of a plurality of image-capturing units may be an image-capturing unit that has no microlens array 102 and performs normal image-capturing.

The control unit 11 has a CPU and peripheral circuits (not shown). The control unit 11 reads predetermined control program from a storage medium (not shown) and executes it to control various units of the image-capturing device 1. The control unit 11 includes a generation unit 11a, a detection unit 11b, a signal processing unit 11c, and an image-capturing control unit 11d. The generation unit 11a generates image data (described later) based on signals that are outputted by the two image-capturing units 10a, 10b upon receiving light. The detection unit 11b detects a subject from the image data generated by the generation unit 11a. The signal processing unit 11c generates distance data (described later) based on the signals outputted by the two image-capturing units 10a, 10b. The image-capturing control unit 11d controls image-capturing of the image-capturing units 10a, 10b with a signal from an operation unit (not shown).

The display unit 12 is, for example, a display device such as a liquid crystal display. The display unit 12 displays, on a display screen, images based on the image data generated by the generation unit 11a of the control unit 11 and information (such as numerical values indicating distances) based on the distance data generated by the signal processing unit 11c. The storage unit 13 has a storage device (not shown) such as a hard disk drive. The storage unit 13 stores the image data and the distance data generated by the control unit 11 in the storage device.

Note that the display unit 12 and the storage unit 13 may be provided outside the image-capturing device 1. For example, the display unit 12 and the storage unit 13 may be included in a computer such as a smartphone or a tablet terminal provided outside the image-capturing device 1. In that case, the image-capturing device 1 transmits the image data and the distance data to the display unit 12 and the storage unit 13 provided outside, via wireless communication or the like.

Further, only one of the display unit 12 and the storage unit 13 may be provided, and the other may be omitted.

Explanation of Refocus Process

The generation unit 11a executes a well-known refocus process based on the signals outputted by the image-capturing units 10a, 10b to generate image data of any image plane in a direction of an optical axis O (i.e., Z direction) of a subject image formed by the image-capturing optical system 101. A refocus process from a signal outputted by one image-capturing unit 10a will be described below.

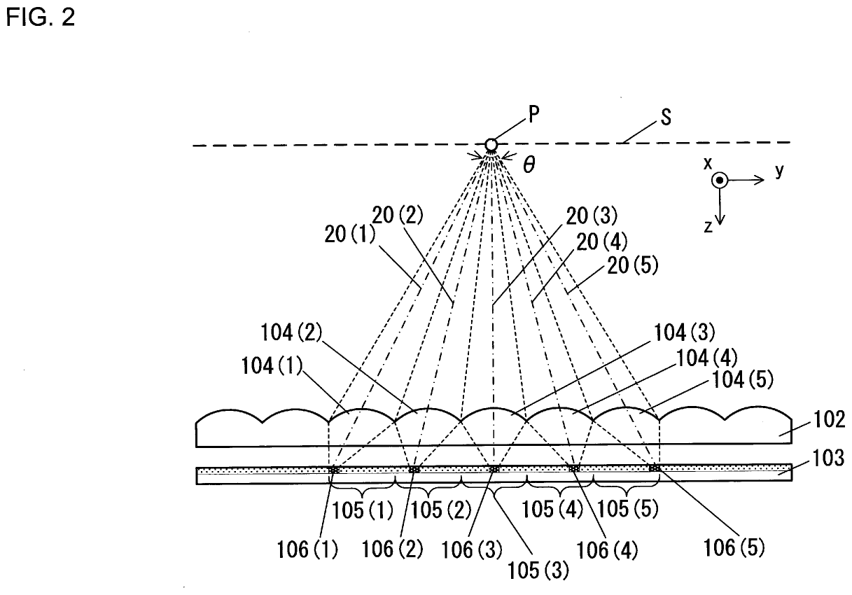

FIG. 2 is a y-z cross-sectional view schematically showing light fluxes from a point P on an image plane S of a subject image formed by the image-capturing optical system 101, and the image-capturing unit 10a. In FIG. 2, a divergence angle θ of the light directing from the point P on the image plane S to the microlens array 102 is defined by the size of a pupil of the image-capturing optical system 101 determined as an aperture value of the image-capturing optical system 101. The aperture value of the microlens 104 is configured to be equal to or smaller than the aperture value of the image-capturing optical system 101.

As shown in FIG. 2, the light fluxes from the point P are incident into, for example, five microlenses 104(1) to 104(5). Light fluxes 20(1) to 20(5) incident into the microlenses 104(1) to 104(5), respectively, pass through the microlenses 104(1) to 104(5) and are then incident into respective light-receiving element groups 105(1) to 105(5).

The generation unit 11a sets a plurality of points P on the image plane S. For each point P, the generation unit 11a determines the microlenses 104 into which light fluxes from the point P are incident. For each determined microlens 104, the generation unit 11a determines into which light-receiving element 106 the light flux from the point P is incident. Thus, the generation unit 11a determines a light-receiving element 106 into which light from a point P on the subject image formed on the image plane S by the image-capturing optical system 101 is incident. In order to generate a subject image formed on the image plane S from light-receiving signals outputted from the light-receiving elements 106, the generation unit 11a adds together the light-receiving signals of the determined light-receiving elements 106 to calculate a pixel value corresponding to each of the points P, and then generates an image from the calculated pixel values to generate image data based on the subject image formed on the image plane S. By performing the same process on an image plane deviated from the image plane S in the optical axis direction, image data of the subject formed on another image plane can be generated.

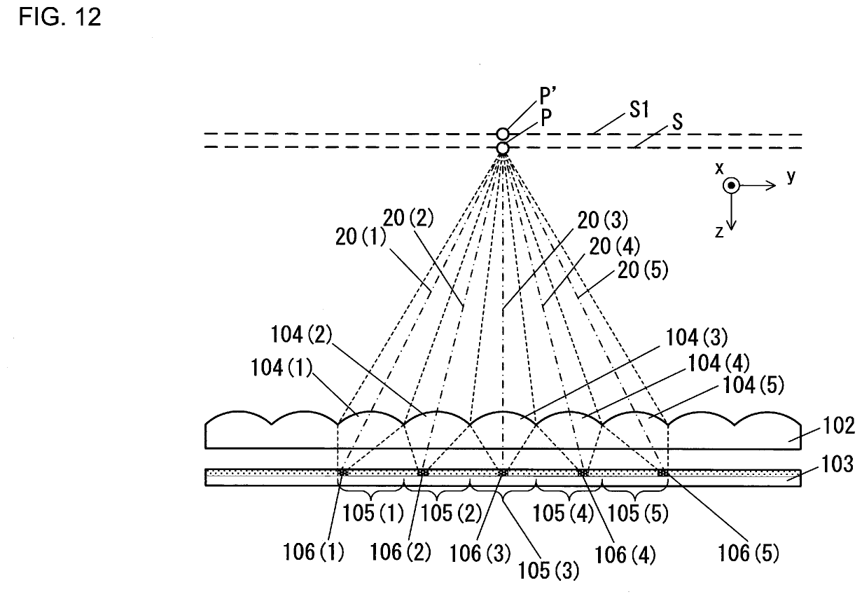

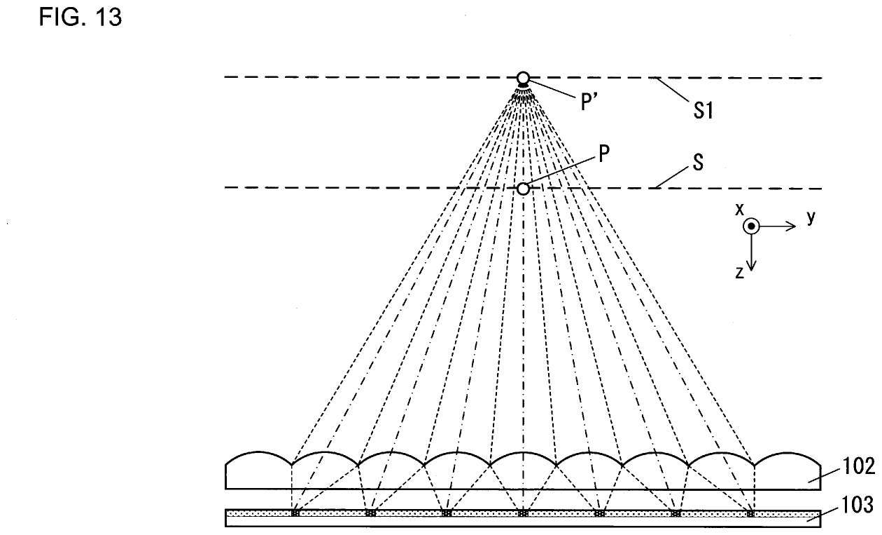

An image plane deviated from the image plane S in the optical axis direction is here defined as S1 and a relationship between image data of a subject formed on the image plane S and image data of a subject formed on the image plane S1, which are generated by the above-described method, will be explained. For example, for an extremely short distance between the image plane S and the image plane S1 as shown in FIG. 12, a light-receiving elements into which light from the point P′ of the subject image formed on the image plane S1 by the image-capturing optical system 101 is incident are the same as the light-receiving elements 106 into which light from the point P of the subject image formed on the image plane S is incident. In other words, the generation unit 11a determines the same light-receiving elements 106. Since lights are incident into the same light-receiving elements, the generated image data items are the same. On the other hand, for a long distance between the image plane S and the image plane S1 as shown in FIG. 13, light-receiving elements into which light from the point P′ of the subject image formed on the image plane S1 by the image-capturing optical system 101 is incident are different from the light-receiving elements 106 into which light from the point P of the subject image formed on the image plane S is incident. The image data items are generated by adding together the light-receiving signals of the different light-receiving elements. The generated image data items are therefore different.

An image plane deviated from the image plane S by a predetermined amount in the optical axis direction will be defined as S2. When image data items of the subject formed on a large number of image planes located between the image plane S and the image plane S2 are generated by the above-described method, a resolution in the optical axis direction in the refocus process can be said to be higher as the number of generated image data items which are mutually different increases. For a high resolution in the optical axis direction in the refocus process, images of the subject at a plurality of positions spaced at small intervals in the optical axis direction of the image-capturing optical system can be generated.

In order to increase the resolution in the optical axis direction in the refocus process, it is only necessary to increase the angle θ at which the light flux from the point P of the subject image in FIG. 2 is incident. For a small angle θ at which the light flux from the point P is incident, light from the point P is incident into only a light-receiving element 106(3), for example. In this case, the pixel value corresponding to the point P is calculated using only the light-receiving signal of the light-receiving element 106(3). Next, a light-receiving element into which light from a point P′ on the image plane S1 deviated from the image plane S in the optical axis direction is incident will be considered. Light from the point P′ on the image plane S1 is also incident into only the light-receiving element 106(3). In other words, a small angle θ at which the light flux from the point P is incident means that the image-capturing optical system 101 provides deep-focus and the resolution in the optical axis direction in the refocus process is low.

On the other hand, for a large angle θ at which the light flux from the point P is incident, light from the point P is incident, for instance, into light-receiving elements 106(1) to 106(5). In this case, the pixel value corresponding to the point P is calculated using the light-receiving signals of the light-receiving elements 106(1) to 106(5). Next, a light-receiving element into which light from a point P′ on the image plane S1 deviated from the image plane S in the optical axis direction is incident will be considered. Regardless of the magnitude of the angle θ at which the light flux is incident, the light from the point P′ on the image plane S1 is incident into the light-receiving element 106(3). However, the light from the point P′ is no longer incident into the light-receiving elements 106(1) and 106(5) located at a large angle from the optical axis passing through the point P. This is because that the farther a position is located from the optical axis, the larger a change in positions on the XY plane of the light-receiving pixel into which the light from the point P is incident and the light-receiving pixel into which the light from the point P′ is incident, with respect to the deviation amount of the image plane S1 from the image plane S in the optical axis direction. In other words, it can be said that a light-receiving element located at a larger angle from the optical axis passing through the point P is more sensitive to the deviation amount of the image plane S1 from the image plane S in the optical axis direction.

In refocus photographing capable of generating an image focusing on any surface of a subject after photographing, images of the subject can be generated at a plurality of positions spaced at smaller intervals in the optical axis direction of the image-capturing optical system, with a larger angle of light incident from a point P of a subject image of the subject to be photographed.

The generation unit 11a executes the refocus process described above to generate image data of the image plane S designated as a generation target. The generation unit 11a can generate image data of a plurality of different image planes for each of the image-capturing units 10a, 10b based on signals outputted from the image-capturing units 10a, 10b in one image-capturing operation.

Next, a method of generating image data of any image plane based on signals outputted from the two image-capturing units 10a, 10b will be described. The generation unit 11a can generate a data item of a single image formed on a predetermined image plane based on signals outputted from the image-capturing units 10a, 10b in one image-capturing operation.

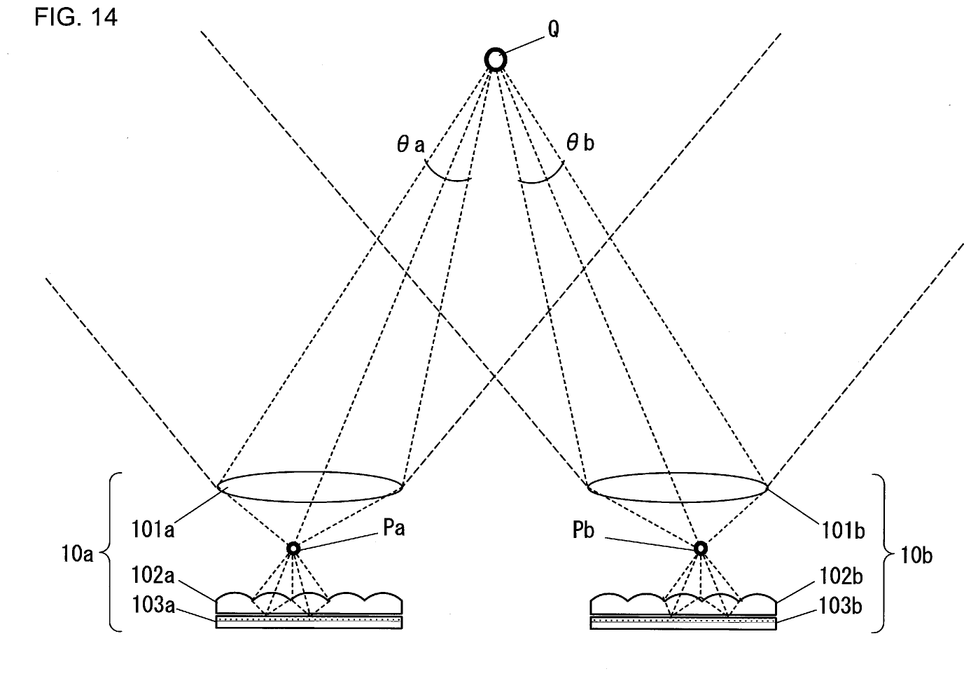

This will be described below with reference to FIG. 14. In FIG. 14, for simplicity of explanation, a specific part of a subject will be defined as a point Q. Light from the point Q which is a specific part of the subject is incident into the image-capturing optical system 101a of the image-capturing unit 10a and the image-capturing optical system 101b of the image-capturing unit 10b. In the image-capturing unit 10a, an image of the light from a point Q which is a specific part of the subject is formed at a light point Pa by the image-capturing optical system 101a, and a light flux from the light point Pa is incident into some microlenses of the microlens array 102a. The light flux from the light point Pa having passed through the microlens is incident into the light-receiving element group which is arranged so as to correspond to the microlens into which the light flux is incident. Likewise, in the image-capturing unit 10b, an image of the light from a point Q is formed at a light point Pb by the image-capturing optical system 101b, and a light flux from the light point Pb is incident into some microlenses of the microlens array 102b. The light flux from the light point Pb having passed through the microlens is incident into the light-receiving element group which is arranged so as to correspond to the microlens into which the light flux is incident.

In order to generate image data of a predetermined image plane by the generation unit 11a, the light-receiving signal from the light-receiving element into which the light flux from the light point Pa in FIG. 14 is incident and the light-receiving signal from the light-receiving element into which the light flux from the light point Pb in FIG. 14 is incident are added together to generate image data corresponding to the point Q which is a predetermined portion of the subject. By performing the same process for all portions of the subject 1 to be imaged by the image-capturing optical system 101, image data of an image plane conjugate to the subject 1 to be imaged by the image-capturing optical system 101 can be generated. Even when the two image-capturing units 10a, 10b are used, image data of the image plane designated as a generation target is generated.

Referring to FIG. 14, comparison is made between a case where the image-capturing unit 10b does not exist and only the image-capturing unit 10a captures an image of the subject and a case where the image-capturing unit 10a and the image-capturing unit 10b capture images of the subject. A light flux of an angle θa among light fluxes from the point Q is incident into the image-capturing unit 10a via the point Pa and a light flux of an angle θb among light fluxes from the point Q is incident into the image-capturing unit 10b via the point Pb. The angle θa changes depending on a distance between the image-capturing unit 10a and the point Q. As the distance between the image-capturing unit 10a and the point Q increases, the angle θa decreases. The angle θa of light from a specific far subject becomes small if only with a signal outputted from one image-capturing unit 10a. Therefore, as described above, it is not possible to generate images of the subject at a plurality of positions spaced at small intervals in the optical axis direction of the image-capturing optical system, the images being generated by the light-receiving signals from the light-receiving elements into which the light fluxes from the light point Pa are incident. On the other hand, use of both the signal from the image-capturing unit 10a and the light-receiving signal from the image-capturing unit 10b allows use of signals based on a light flux from the angle θa and a light flux from angle θb among light fluxes from the point Q. As a result, a wide angle is obtained by combining angles θa and Ob of light from a specific far subject, and images of the subject at a plurality of positions spaced at small intervals in the optical axis direction of the image-capturing optical system can thus be generated. Note that either one of the image-capturing unit 10a and the image-capturing unit 10b may be an image-capturing device that does not have the microlens array 102 and performs normal image-capturing.

Next, a ranging process will be described. The signal processing unit 11c generates data indicating a distance to a subject by executing a well-known ranging process on light-receiving signals outputted by the image-capturing units 10a, 10b. Firstly, in order to detect a subject, the detection unit 11b performs well-known image processing, such as template matching, on the light-receiving signals outputted from the image-capturing units 10a, 10b. A distance to the subject detected by the detection unit 11b is detected by the signal processing unit 11c. The ranging process executed by the signal processing unit 11c will be described below.

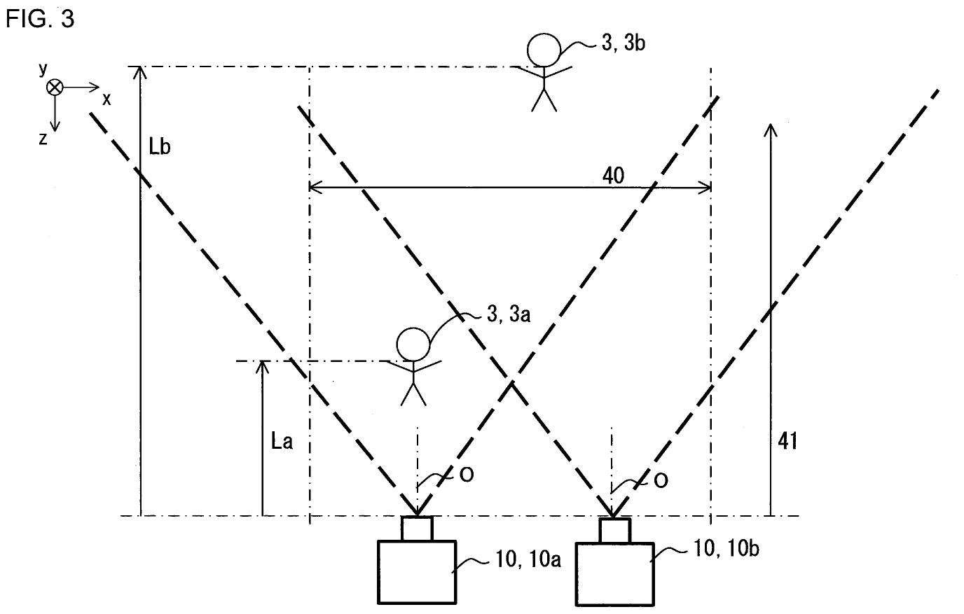

FIG. 3 is a view for explaining a ranging process and shows two image-capturing units 10a, 10b arranged in the horizontal (X-Z plane) direction and the subjects 3a, 3b as seen from above (Y direction). In FIG. 3, image-capturing ranges (angles of view) of the two image-capturing units 10a, 10b are indicated by broken lines. The two image-capturing units 10a, 10b are arranged so that optical axes O of image-capturing optical systems 101 of the two image-capturing units 10a, 10b are parallel to one another. In FIG. 3, two subjects 3a, 3b (collectively referred to as subject 3) are located within image-capturing ranges of the two image-capturing units 10a, 10b. One subject 3a is present within the image-capturing range of the image-capturing unit 10a and out of the image-capturing range of the image-capturing unit 10b. Other subject 3b is located at a position within the image-capturing range of the image-capturing unit 10a and within the image-capturing range of the image-capturing unit 10b. In other words, an image of the subject 3a is captured only by the image-capturing unit 10a, an image of the subject 3b is captured by both the image-capturing unit 10a and the image-capturing unit 10b. The subject 3a has a distance La from the image-capturing units 10a, 10b in the optical axis O direction (Z direction). The subject 3b has a distance Lb, which is longer than the distance La, from the image-capturing units 10a, 10b in the optical axis O direction (Z direction).

Under a control of the image-capturing control unit 11d of the control unit 11, the image-capturing unit 10a and the image-capturing unit 10b capture images of the subject 3. The generation unit 11a generates image data of a predetermined one image plane (hereinafter referred to as first image data) from the light-receiving signal of the image-capturing unit 10a. Similarly, the generation unit 11a generates image data (hereinafter, referred to as second image data) on the same image plane as that of the first image data from the light-receiving signal of the image-capturing unit 10b. Although each of the first image data and the second image data is explained as image data of a predetermined one image plane generated by the refocus process, the first image data and the second image data may be deep-focus image data generated from the light-receiving signals of the image-capturing units 10a, 10b, respectively. The deep-focus image data can be generated, for example, by a well-known method of generating a pixel value of image data for each microlens by light-receiving signals from one or more light-receiving elements correspondingly arranged in the vicinity of the center of each microlens.

The detection unit 11b performs subject recognition processing on the first image data generated as deep-focus image data and detects the subject 3a that is present on the generated image plane. The detection unit 11b performs the subject recognition processing by well-known image processing such as template matching. The detection unit 11b performs subject recognition processing on the second image data synthesized as deep-focus image data, as in the case of the first image data. The detection unit 11b detects the subject 3b from the second image data.

The signal processing unit 11c generates distance data by executing a first ranging process on the subject 3a detected from only the first image data. The first ranging process is to calculate a distance based on the light-receiving signal outputted by the image-capturing unit 10a. The signal processing unit 11c generates distance data by executing a second ranging process on the subject 3b detected from both the first image data and the second image data. The second ranging process is to calculate a distance based on the light-receiving signals outputted by both the image-capturing unit 10a and the image-capturing unit 10b.

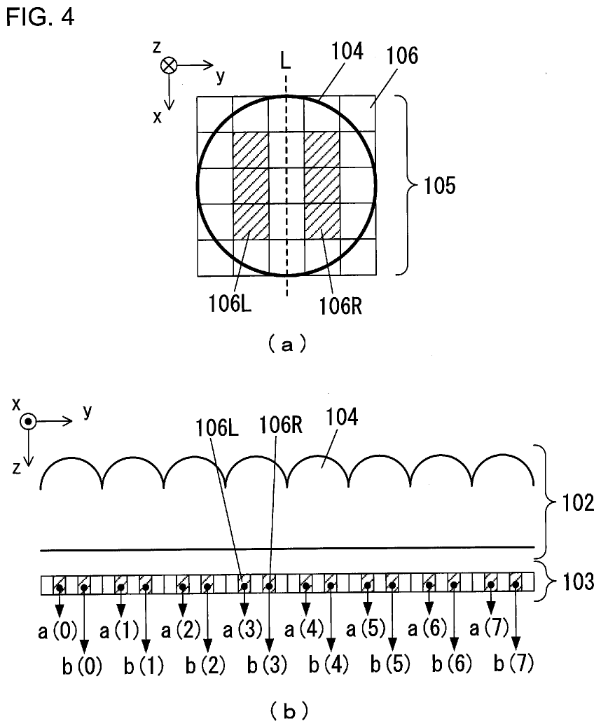

FIG. 4 illustrates the first ranging process. FIG. 4(a) is a plan view of one microlens 104 and a light-receiving element group 105 as seen from a subject side, and FIG. 4(b) is a cross-sectional view of the microlens array 102 and the light-receiving element array 103 as seen from the same direction as in FIG. 2.

The signal processing unit 11c performs a ranging operation using light-receiving signals from a total of six light-receiving elements 106 in an area indicated by hatching in FIG. 4(a) in the first ranging process. These six light-receiving elements 106 are divided into three light-receiving elements 106L and three light-receiving elements 106R. The three light-receiving elements 106L and the three light-receiving elements 106R are arranged in line-symmetric positions with respect to a straight line L passing through the optical axis of the microlens 104. The use of a total of six light-receiving elements 106 for the ranging process is only an example; the number of light-receiving elements to be used is not limited to six, and an appropriate number may be used based on the number of light-receiving elements 106 included in the light-receiving element group 105.

The signal processing unit 11c generates signals a(0), a(1), a(2), . . . , a(7) obtained by adding together light-receiving signals from the three light-receiving elements 106L and signals b(0), b(1), b(2), b(7) obtained by adding together light-receiving signals from the three light-receiving elements 106R, for each of the eight microlenses 104 shown in FIG. 4(b). The signal processing unit 11c performs correlation calculation between a pair of signal strings a(i), b(i) generated in this way to calculate a correlation amount (i=0 to 7). Here, a generally known arithmetic operation can be used for calculating the correlation amount. The control unit 11 shifts a(i) and b(i) a little at a time and repeatedly performs the correlation calculation to calculate a correlation amount for each shift amount. The signal processing unit 11c determines a shift amount at which the correlation amount is the maximum amount. The shift amount determined here corresponds to a difference between the current image-forming position of the image-capturing optical system 101 and a position at which an image of the subject is formed on the image-capturing element. The signal processing unit 11c calculates a distance to a subject b using the current focal length of the image-capturing optical system 101 and the determined shift amount.

Note that the three light-receiving elements 106L and three light-receiving elements 106R used to obtain the pair of signal strings a(i), b(i) can determined in the light-receiving element group 105 as appropriate. For example, a pair of signal strings a(i), b(i) may be obtained from two light-receiving elements 106L and two light-receiving elements 106R. Note that the number of the light-receiving elements 106L and the number of the light-receiving elements 106R each may be four or more elements, or each may be one.

The first ranging process provides a ranging operation having a high accuracy when a distance to a subject is equal to or less than a certain distance. In the first ranging process, a distance cannot be correctly measured when a distance to a subject exceeds a certain distance. This is because that a parallax for a subject located far to some extent becomes small as seen from the light-receiving elements 106L and 106R used to create a pair of signal strings a(i), b(i). The certain distance is determined by a space (baseline length) between the light-receiving elements 106L and 106R used for creating the pair of signal strings a(i), b(i). As the baseline length increases, a ranging operation having a high accuracy can be performed for a farther subject; however, because of the configuration of the image-capturing unit 10, the baseline length is limited by the size of each microlens 104, the size of the microlens array 102, and a F-number of the image-capturing optical system 101.

The second ranging process will be described. The signal processing unit 11c picks up a pixel value on a subject 3b in the first image data among pixel values in one row of the first image data, as a first signal string. The signal processing unit 11c picks up a pixel value in the same position on the subject 3b among pixel values in one row of the second image data, as a second signal string. The first signal string and the second signal string are used to perform the same calculation as in the above-described first ranging process. In other words, the signal processing unit 11c repeatedly performs a correlation calculation between the first signal string and the second signal string while shifting the signal strings pixel by pixel, to determine a shift amount at which the correlation is the highest. Then, the signal processing unit 11c calculates a distance to the subject 3b by multiplying the determined shift amount by a predetermined factor.

As described above, as the baseline length increases, a ranging operation having a high accuracy can be performed for a farther subject. The baseline length in the second ranging process is a distance between the image-capturing unit 10a and the image-capturing unit 10b. This distance is longer than the baseline length in the first ranging process restricted by the size of the microlens of one image-capturing unit 10a or 10b. Therefore, the second ranging process provides a ranging operation having a high accuracy for a farther subject, compared with the case in the first ranging process.

Note that positions at which the image-capturing unit 10a and the image-capturing unit 10b are installed are desirably determined in a suitable manner, based on image-capturing ranges of the image-capturing unit 10a and the image-capturing unit 10b, the above-described certain distance (the distance that can be measured through a ranging operation with only the light-receiving signal from one image-capturing unit 10), and a range to be monitored. Specifically, within a range to be monitored, the image-capturing units 10 are desirably arranged so that a subject farther than the above-described certain distance is included in the image-capturing ranges of both of the image-capturing units 10. For example, in FIG. 3, when a range 40 to be monitored is determined and the above-mentioned certain distance is a distance denoted by reference numeral 41, the image-capturing units 10a, 10b are arranged so that a range farther than the distance denoted by reference numeral 41 is included in image-capturing ranges of both of the image-capturing units 10a, 10b. Such an arrangement of the image-capturing units 10a, 10b provides a reliable measurement of a distance of a far subject within a range to be monitored.

In the above description, the control unit 11 calculates one single distance for each subject; however, it is also possible to calculate a distance for each part of the subject to create a so-called depth map. In other words, the control unit 11 can also generate data of a two-dimensional array of distances to subject portions at each position in a photographing screen.

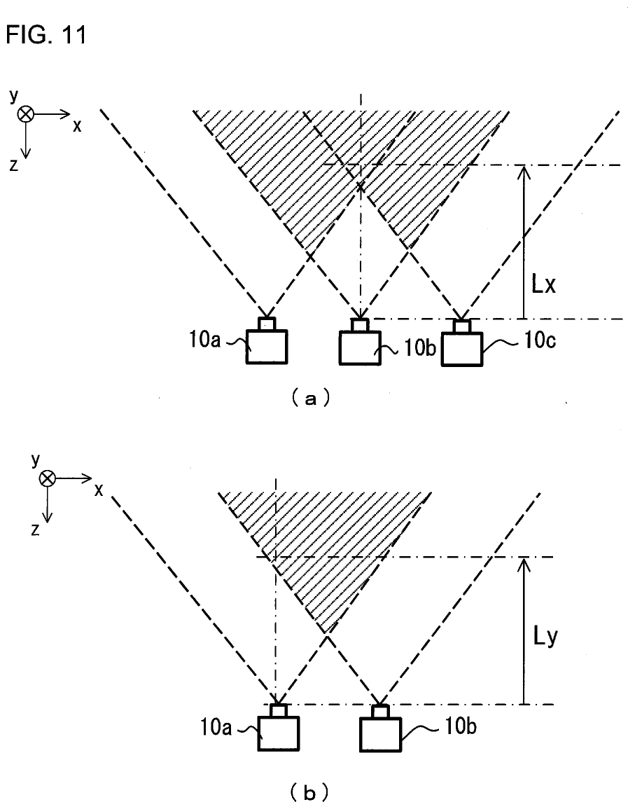

In a case where there are three image-capturing units 10a, 10b, 10c as shown in FIG. 11(a), the image-capturing units 10a, 10b, 10c are preferably installed such that a subject to be monitored that is located at a distance farther than a distance Lx within which distance information can be calculated by one of the image-capturing units 10a, 10b, 10c, is included in a range (hatched region in FIG. 11(a)) which can be captured by at least two image-capturing units 10a, 10b and 10b, 10c simultaneously. This is because even if the subject located within the range to be monitored is located at a distance farther than the distance Lx, distance information can be calculated so long as the subject is included in the photographing range of at least two of the image-capturing units 10a, 10b, 10c. In a case where there are two image-capturing units 10a, 10b as shown in FIG. 11(b), the image-capturing units 10a, 10b are preferably installed such that a subject to be monitored that is located at a distance farther than a distance Lx within which distance information can be calculated by one of the two image-capturing units 10a, 10b, is included in a range (hatched region in FIG. 11(b)) which can be captured by the two image-capturing units 10a, 10b simultaneously. By installing the image-capturing units as described above, distance information can be calculated even for a subject located at a distance farther than a distance within which one image-capturing unit can calculate distance information. As a result, the range to be monitored have no subranges in which distance information cannot be calculated.

Such an arrangement of the plurality of image-capturing units 10 can be similarly achieved by considering ranges where the refocus process can be performed. Specifically, the image-capturing units 10a, 10b, 10c are preferably installed such that a subject located at a distance within which a refocus process can be performed on a light-receiving signal outputted by one of the image-capturing units 10a, 10b, 10c to generate image data on a predetermined image plane is included in a range (hatched region in FIG. 11(a)) which can be captured by at least two of the image-capturing units 10a, 10b, 10c simultaneously.

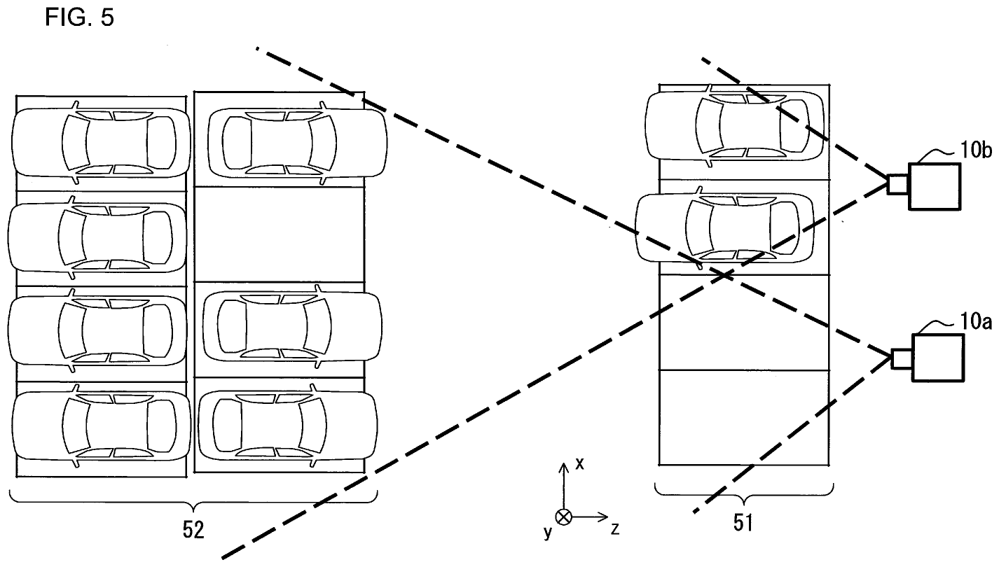

The image-capturing device 1 configured as described above may be used as a surveillance camera for security purposes, for example. For example, as shown in FIG. 5, the image-capturing device 1 arranged in a parking lot can simultaneously monitor a parking row 51 located near to the image-capturing device 1 and a parking row 52 located far from the image-capturing device 1. If only one normal camera (a camera that is not capable of refocus process) is used, distances cannot be simultaneously determined in the parking row 51 located near to the camera and the parking row 52 located far from the camera, so that an image focusing on a specific subject to be monitored is not always obtained. Additionally, if only one image-capturing unit 10 capable of refocus process is installed, a ranging operation may be not performed for a far subject having a small parallax. However, the above-described image-capturing device 1 has two image-capturing units 10a, 10b and the parallax can thus be increased by increasing the baseline length with the image-capturing unit 10a and the image-capturing unit 10b to accurately measure a distance for a farther subject.

Furthermore, image data capable of generating an image on a predetermined image plane by performing refocus process and distance data can be simultaneously acquired in one image-capturing. It is therefore possible to acquire distance data indicating at which parking row a suspicious person (i.e., a subject) is located, and image data including face information and the like of the subject without a time lag. In particular, a system configured to register suspicious behavior patterns of suspicious persons in advance by using machine learning such as deep learning and automatically notify security guards and the like of detected suspicious behavior can more effectively perform crime prevention. The conventional image-capturing device, which has a narrow focusing range, requires a larger number of image-capturing units to cover such a wide range as a monitoring target. Further, in order to simultaneously obtain image data, which is capable of generating images on a predetermined image plane by performing refocus process, and distance data in a range from a short distance to a long distance, it is necessary to arrange a plurality of different devices for each purpose.

Conventional cameras capable of a ranging operation have problems that they have a narrow range in which a ranging operation can be performed with a high accuracy, or they cannot be used outdoors because external light other than light from a light source used for measurement enters into the cameras. A scheme of this embodiment can solve these problems because a range in which a ranging operation can be performed with a high accuracy is larger and no light source for measurement is used.

Additionally, three-dimensional ranging operations such as operations with time of flight (TOF) devices cannot obtain color information on ranging points. On the other hand, this scheme can obtain color information.

Further, the image-capturing device 1 can be utilized as a surveillance camera having purposes other than crime prevention. For example, the image-capturing device 1 is installed in a shopping mall and a passage and a front space a shop are set as image-capturing ranges. In this way, image data and distance data can be simultaneously obtained for both passerby on the passage and customers in front of the shop to obtain marketing information such as customer's flow line and staying time of the customers in the shop.

Additionally, the image-capturing device 1 can have other purposes as well as crime prevention. For example, the image-capturing device 1 is installed in a jewelry shop, and showcases having jewelry goods therein and passages in front of the shop are set as image-capturing ranges. In this way, information on goods contained in the showcases and thieves approaching them, and information on passerby passing through in front of the store and customers entering the shop can be simultaneously obtained. The former information can be used for crime prevention purpose and the latter information can be used for marketing purpose.

Similarly, the image-capturing device 1 can be used for cameras that monitor vending machines and automatic ticket vending machines, cameras that monitor aviation facilities, port facilities, and the like, cameras that monitor station ticket gates, cameras that monitor train doors and station platforms, and the like. For monitoring train doors and station platforms, the train doors and station platforms can be simultaneously monitored by installing an image-capturing unit 10 for each train door.

Furthermore, the image-capturing device 1 can be used as a so-called drive recorder installed in an automobile. In this case, the image-capturing device 1 can record not only image data, but also distance data of surrounding vehicles and the like. Thus, in case of an accident, for example, the accident situation can be more properly grasped. Note that the image-capturing device 1 may be used as an image-capturing device installed in an automobile which is used for driving support (braking operation and steering) and automatic driving, in addition to the drive recorder.

Further, the image-capturing device 1 according to the present embodiment is configured to generate image data and acquire distance data. The image-capturing device 1 can thus easily perform tracking at the time of a subject passing by other persons or objects, which was difficult with conventional image-capturing devices. The term “tracking at the time of a subject passing by other persons or objects” refers to a situation where a passerby to be tracked walks from left to right, while another passerby walks from right to left and passes by the passerby to be tracked. In such a case, in conventional subject tracking based on the shape, color, and the like of the subject, the passerby may be erroneously considered as the tracking target after a passerby has passed by the tracking target. In the image-capturing device 1 according to the present embodiment, such erroneous recognition can be avoided since distance data can be used for the tracking process.

Note that the image-capturing device 1 can be suitably used besides the above-described uses. For example, the image-capturing device 1 can be used for location survey or the like in map creation.

According to the above-described embodiment, the following operational advantages can be achieved.

(1) A plurality of image-capturing units capable of refocus photographing are arranged so that their photographing ranges overlap each other. Thus, images of a subject at a plurality of positions spaced at small intervals in the optical axis direction of the image-capturing optical system can be generated for a subject located at a distance within which images of the subject at a plurality of positions spaced at small intervals in the optical axis direction of the image-capturing optical system cannot be generated using one single image-capturing unit. Additionally, images of a subject are generated using signals outputted from a plurality of image-capturing units. Thus, images of a first subject among subjects at a plurality of positions in the optical axis direction of the image-capturing optical system can be generated at small intervals for a subject located at a distance within which images of the first subject among subjects at a plurality of positions in the optical axis direction of the image-capturing optical system cannot be generated at small intervals using one single image-capturing unit.

(2) The control unit 11 calculates distance data of a far subject based on signals from two image-capturing units, and further calculates distance data of a near subject based on a signal from either one of the two image-capturing units. In this way, the distance can be measured with a high accuracy for both a far subject and a near subject.

(3) The control unit 11 functions as a subject detection unit that detects a subject from the image-capturing range of each of the two image-capturing units 10a, 10b. The control unit 11 calculates distance data of the subject detected from the image-capturing ranges of the two image-capturing units 10a, 10b based on respective light-receiving signals. In this way, it is possible to calculate a distance only for a target subject for ranging and omit calculation of a distance for subjects other than the target subject for ranging, thereby reducing the time required for the ranging calculation.

(4) The control unit 11 functions as an image creation unit that creates image data of a subject based on at least one of the two light-receiving signals. In this way, distance data and image data can be simultaneously obtained by one image-capturing. Additionally, when image processing such as face detection is performed on image data, not only two-dimensional image data, but also distance data can be used to reduce erroneous detection in image processing such as face detection.

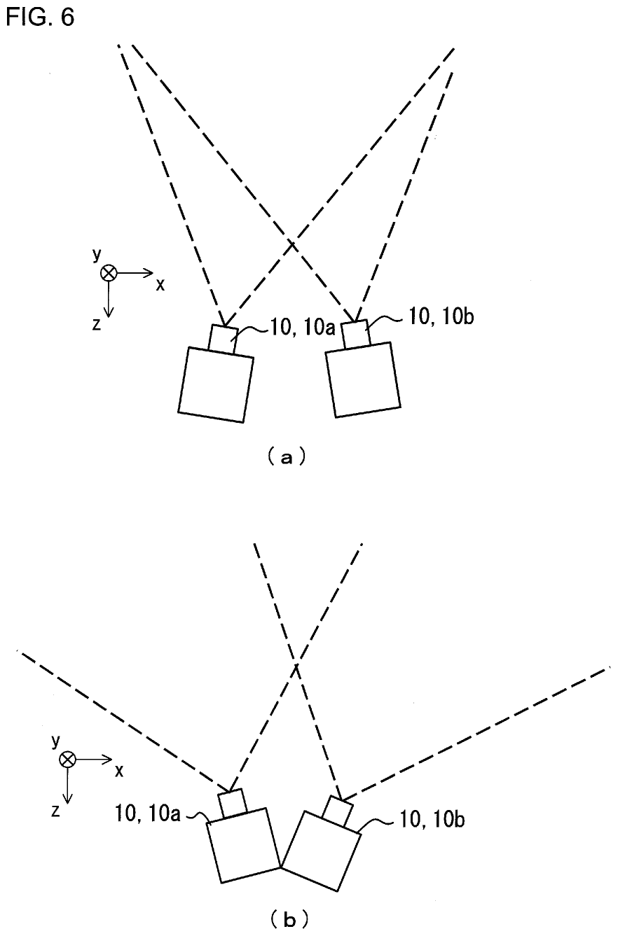

Note that the arrangement of the image-capturing unit 10 may be different from that illustrated in FIG. 3. For example, as illustrated in FIG. 6(a), the image-capturing units 10a, 10b may be arranged with an inward angle so that the optical axes O of the image-capturing units 10a, 10b cross each other. Conversely, as illustrated in FIG. 6(b), the image-capturing units 10a, 10b may be arranged with an outward angle so that the optical axes O of the image-capturing units 10a, 10b do not intersect each other.

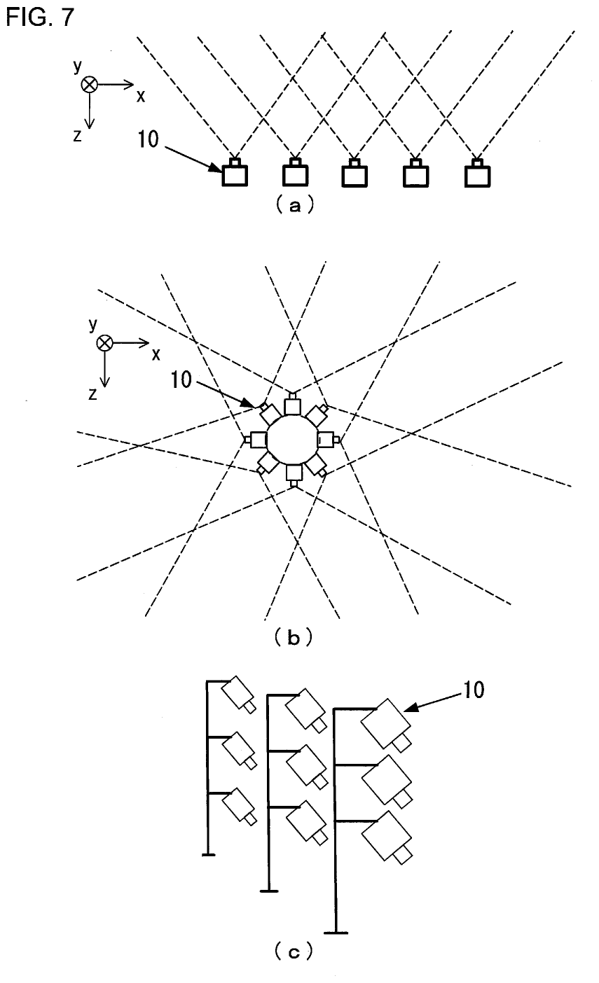

Note that the image-capturing device 1 may have three or more image-capturing units 10. For example, as illustrated in FIG. 7(a), three or more image-capturing units 10 may be arranged in parallel so that the optical axes O of the image-capturing units 10 are parallel to each other. Additionally, as illustrated in FIG. 7(b), eight image-capturing units 10 may be arranged so that the optical axes O of the image-capturing units extend in radial directions. Furthermore, as illustrated in FIG. 7(c), nine image-capturing units 10 may be arranged two-dimensionally in arrays having 3 rows with 3 columns.

Note that a ranging method of a subject captured by a plurality of image-capturing units 10 may be different from the above-described ranging method. For example, a ranging method used in a so-called stereo camera may be applied by using image data created from the light-receiving signal of the image-capturing unit 10a and image data created from the light-receiving signal of the image-capturing unit 10b. In other words, there is a deviation between such two image data due to a parallax between the image-capturing unit 10a and the image-capturing unit 10b. The deviation varies according to the distance from the image-capturing units 10a and 10b, and thus calculating a deviation amount and multiplying the deviation amount by a predetermined factor makes it possible to determine the distance of the subject.

Note that a ranging process may be different from that in the above-described embodiment. For example, in the above-described embodiment, a subject is first detected, and the first ranging process is performed when the subject is detected by only one of the image-capturing units, and the second ranging process is performed when the subject is detected in both of the image-capturing units. In addition to the ranging process, for example, the signal processing unit 11c first attempts to execute the first ranging process based on only the light-receiving signal from the image-capturing unit 10a for the entire image-capturing range of the image-capturing unit 10a. Similarly, the signal processing unit 11c attempts to execute the first ranging process based on only the light-receiving signal from the image-capturing unit 10a for the entire image-capturing range of the image-capturing unit 10b. When a far subject is included within the image-capturing range, a parallax of the far subject seen from one single image-capturing unit is small. The accuracy in ranging on the subject therefore decreases. The signal processing unit 11c executes the second ranging process based on light-receiving signals from both of the image-capturing units for the far subject. In this way, the subject recognition process may be eliminated.

### Second Embodiment

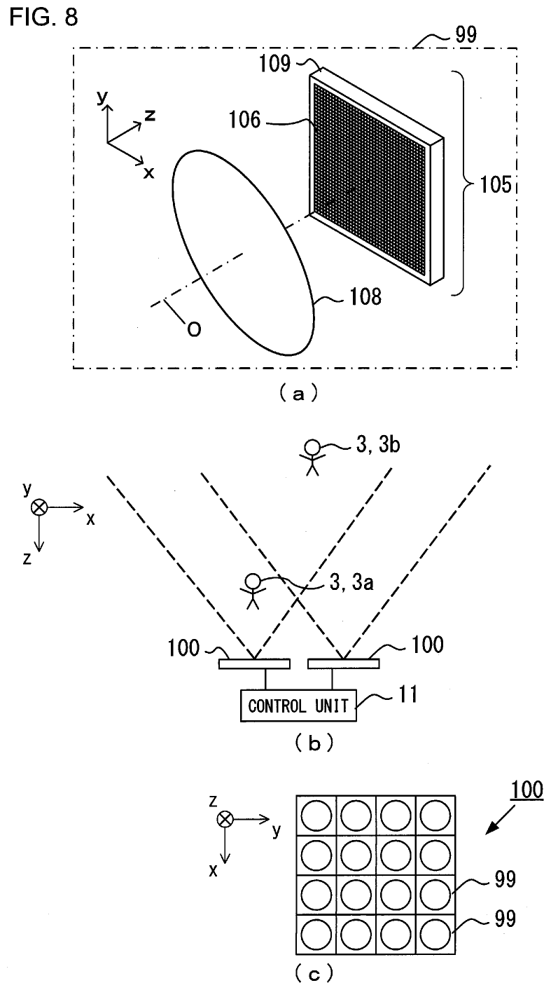

In the first embodiment, an image-capturing device having a configuration using two refocus cameras is illustrated as the image-capturing unit 10. However, the image-capturing device may be configured as a so-called multi-camera in which a plurality of normal cameras are arranged. For example, instead of the image-capturing unit 10 of FIG. 1, a plurality of image-capturing units 99 shown in FIG. 8(a) may be provided. One image-capturing unit 99 includes an image sensor 109 having a plurality of light-receiving elements arranged two-dimensionally with the image-capturing optical system 108. An image-capturing unit 100 in a second embodiment described below has a plurality of image-capturing units 99 arranged two-dimensionally.

FIG. 8(b) shows a state in which two image-capturing units 100 illustrated in FIG. 8(c) are arranged. An image-capturing device having the image-capturing unit 100 arranged therein, instead of the image-capturing unit 10, has the same function as the image-capturing device 1 illustrated in FIG. 1. For example, a light-receiving signal which is captured and outputted by each image-capturing unit 99 included in the image-capturing unit 100 is used to perform a refocus process of synthesizing image data on a predetermined image plane in the optical axis direction of the image-capturing optical system 108 from light-receiving signals outputted by one image-capturing unit 100. The image-capturing units 99 are spaced apart from each other in a direction perpendicular to the optical axis O of the image-capturing optical system 108. Thus, the light-receiving signals captured and outputted by the image-capturing units 99 have a parallax. By processing the image data items deviated in a direction perpendicular to the optical axis O of the image-capturing optical system 108 which are captured and generated by the image-capturing units 99, the image data items on a predetermined image plane in the optical axis direction of the image-capturing optical system 108 can be synthesized. It is possible to change the position of the image plane in the optical axis direction of the image-capturing optical system 108 for the image data to be synthesized by using image data items having different deviation amount in a direction perpendicular to the optical axis direction of the image-capturing optical system 108.

Applying the refocus process for one image-capturing unit 100 described above on two image-capturing units 100 enables the image data on a predetermined image plane to be synthesized from light-receiving signals of the two image-capturing units 100. Specifically, when light from a subject is incident into both of the two image-capturing units 100, a light-receiving signal deviated in a direction perpendicular to the optical axis direction of the image-capturing optical system 108, among a light-receiving signal captured and outputted by each image-capturing unit 99 of one image-capturing unit 100 and a light-receiving signal captured and outputted by each image-capturing unit of the other image-capturing unit 100, is used to perform processes such as addition so that image data on a predetermined image plane in the optical axis direction of the image-capturing system 108 can be synthesized. It is possible to change the position of the image plane in the optical axis direction of the image-capturing optical system 108 for the image data to be synthesized by changing deviation amounts of image data items in a direction perpendicular to the optical axis direction of the image-capturing optical system 108.

Note that use of the two image-capturing units 100 as in FIG. 8(b) allows a space between the two image-capturing units 100 to be increased and the parallax to be increased. Therefore, it is possible to synthesize image data items on image planes in a range in the optical axis direction of the image-capturing optical system 108, for a far subject whose image data could not be synthesized with one image-capturing unit 100.

Furthermore, for a ranging process, a distance from the image-capturing device to the subject can be calculated based on a parallax amount of the image based on light-receiving signals captured and outputted by the image-capturing units 99, and based on optical characteristics (focal length and the like) of the lens. Note that use of the two image-capturing units 100 allows a space between the image-capturing units 100 to be increased and the parallax to be increased; thus, the ranging operation can be performed with a high accuracy for a far subject whose distance cannot be measured by one image-capturing unit 100.

Note that optical characteristics (focal length, angle of view, F-number, etc.) of the image-capturing optical systems 108 of the image-capturing units 99 included in each image-capturing unit 100 are not necessarily the same. Furthermore, in one image-capturing unit 100, optical characteristics of the image-capturing optical systems 108 of the image-capturing units 99 are not necessarily the same.

Note that configurations other than the above-described configurations can be applied in the same manner as in the image-capturing device in FIG. 1.

In the image-capturing device according to the second embodiment described above, images of a subject at a plurality of positions spaced at small intervals in the optical axis direction of the image-capturing optical system can be generated for a subject located at a distance within which images of the subject at a plurality of positions spaced at small intervals in the optical axis direction of the image-capturing optical system cannot be generated using one single image-capturing unit.

### Third Embodiment

The image-capturing device 1 according to the first embodiment has two image-capturing units 10a, 10b having the same configuration. An image-capturing device 1001 according to a third embodiment has an image-capturing unit 10x having a configuration different from the above-described image-capturing units. The use of the image-capturing unit 10x achieves a subject image having a resolution higher than that in the case where only the two image-capturing units 10a, 10b are used. Hereinafter, the third embodiment will be described. The same members as those of the first embodiment are denoted by the same reference numerals as those of the first embodiment, and a description thereof will be omitted.

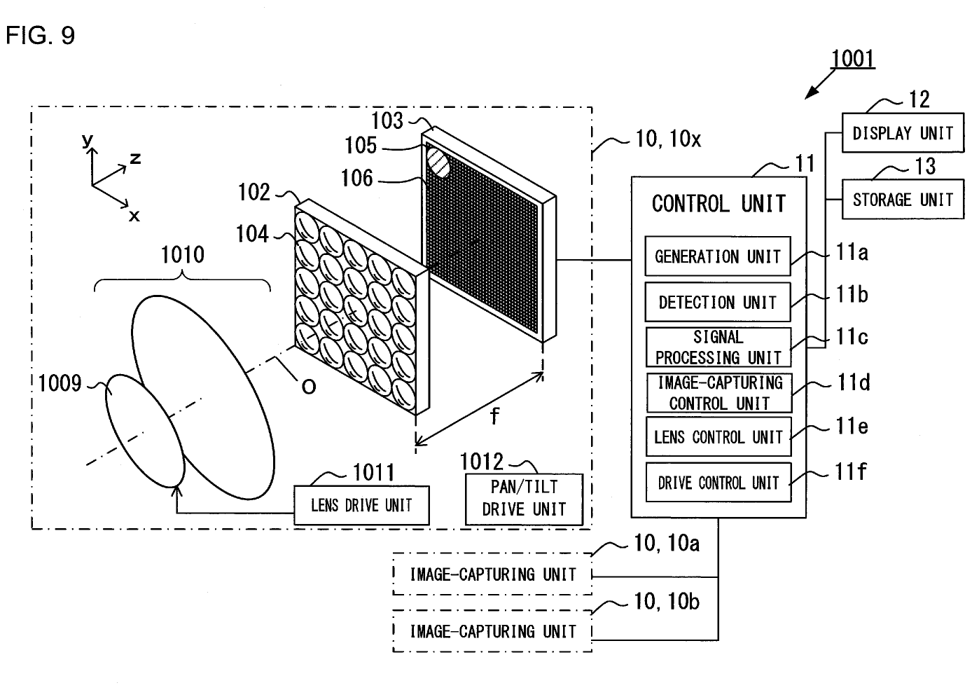

FIG. 9 is a view schematically showing the image-capturing device 1001 according to the third embodiment. The image-capturing device 1001 includes the image-capturing unit 10x, in addition to the image-capturing units 10a, 10b similar to those of the first embodiment. The control unit 11 includes a lens control unit 11e and a drive control unit 11f, in addition to the generation unit 11a, the detection unit 11b, the signal processing unit 11c, and the image-capturing control unit 11d similar to those of the first embodiment.

The image-capturing unit 10x includes a variable power optical system 1010 including a variable power lens 1009 as an image-capturing optical system, a microlens array 102, a light-receiving element array 103, a lens drive unit 1011, and a pan/tilt drive unit 1012. Under a control of the lens control unit 11e, the lens drive unit 1011 drives the variable power lens 1009 in the Z direction of the optical axis O by an actuator (not shown). When the variable power lens 1009 is driven, the focal length of the variable power optical system 1010 changes. Under a control of the drive control unit 11f, the pan/tilt drive unit 1012 changes the orientation of the image-capturing unit 10x in the lateral direction and in the vertical direction by an actuator (not shown).

In the present embodiment, use of the image-capturing device 1001 as a surveillance camera will be described. A user of the surveillance camera designates a subject to be detected as a subject of interest. The control unit 11 reads feature data of the subject of interest through an input unit (not shown), in advance. The feature data includes, for example, template data used for template matching and other feature amounts used for well-known image processing.

Additionally, the signal processing unit 11c performs well-known subject recognition processing on images generated by the image-capturing units 10a, 10b, 10x. The drive control unit 11f drives the pan/tilt drive unit 1012 to track the target detected by the detection unit 11b by the subject recognition processing. The drive control unit 11f drives the pan/tilt drive unit 1012 to change the image-capturing direction of the image-capturing unit 10x so that the detected target falls within the image-capturing range of the image-capturing unit 10x.

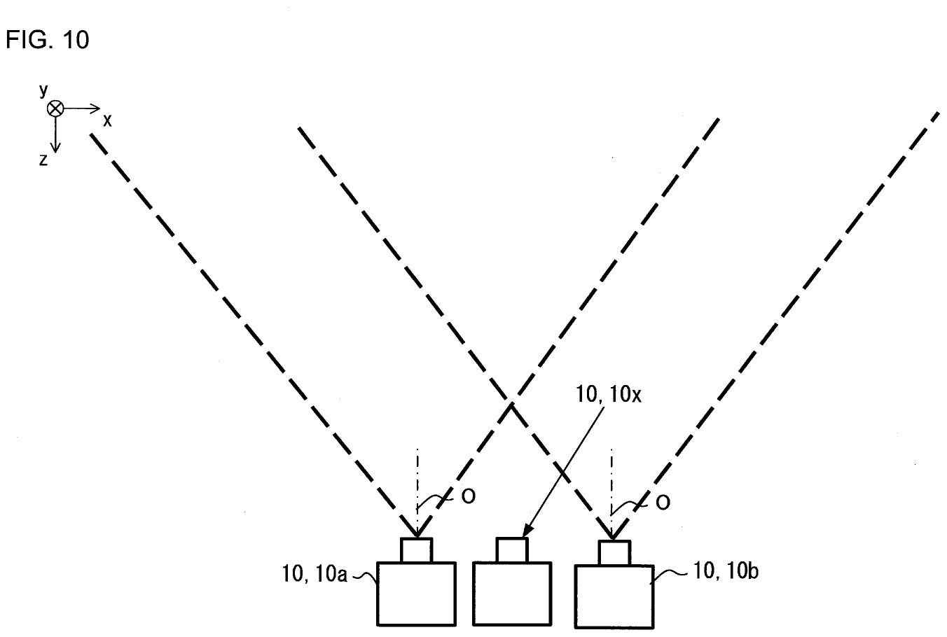

FIG. 10 is a plan view schematically showing an example of an arrangement of the image-capturing units 10a, 10b, 10x. The image-capturing units 10a, 10b are arranged as in the first embodiment, and the image-capturing unit 10x is arranged between the image-capturing unit 10a and the image-capturing unit 10b. Note that the image-capturing range of the image-capturing unit 10x is not shown in FIG. 10 since the orientation and the image-capturing range of the image-capturing unit 10x change.

The generation unit 11a executes well-known subject recognition processing on the image data generated from the light-receiving signal outputted from the image-capturing unit 10a and the light-receiving signal outputted from the image-capturing unit 10b, and the detection unit 11b detects the subject of interest. When the detection unit 11b detects the subject of interest, the drive control unit 11f instructs the image-capturing unit 10x to photograph the subject of interest. When receiving the instruction, the image-capturing unit 10x drives the lens drive unit 1011 and the pan/tilt drive unit 1012 to change the optical axis O to the direction of the determined subject and controls the lens drive unit 1011 to zoom in/out on the subject of interest.

The signal processing unit 11c thereafter generates image data and distance data based on light-receiving signals outputted from the light-receiving element array 103 of the image-capturing unit 10x. The method of generating image data and distance data is the same as in the first embodiment described above. The control unit 11 displays the created image data and distance data on the display unit 12 and stores them in the storage unit 13.

As described above, in the present embodiment, the third image-capturing unit 10x pans/tilts or zooms in on the subject of interest. This allows image data having a larger size, that is, image data having a larger number of pixels to be displayed and stored for the subject of interest. When the image-capturing device of the present embodiment is used for a surveillance camera, use of image data with a large size which has been captured by the third image-capturing unit 10x and then stored makes it easy to confirm an action of the subject of interest after photographing.

According to the above-described embodiment, the following operational advantages can be achieved in addition to the operational advantages of the first embodiment.

(5) The image-capturing device 1001 includes the image-capturing unit 10a, the image-capturing unit 10b, and the image-capturing unit 10x. Among the three image-capturing units 10, one image-capturing unit 10x is configured so that its image-capturing direction is variable. The image-capturing unit 10x changes the image-capturing direction toward a predetermined subject of interest captured by any one of the three image-capturing units 10. In this way, for example, even in a case where only a part of a subject of interest is captured at an edge of an image-capturing range of the image-capturing unit 10a or the image-capturing unit 10b, the image-capturing unit 10x can capture an image of the subject of interest with a larger size and with a higher resolution.

(6) The image-capturing unit 10x has the variable power lens 1009 and the lens drive unit 1011. The lens drive unit 1011 drives the variable power lens so that a zoomed image of the subject of interest is captured. With this configuration, for the subject of interest, image data having a larger size and having the subject of interest zoomed in can be obtained.

Note that the image-capturing unit 10x may have microlenses 104 having variable refractive power. For example, the microlens 104 is a liquid crystal lens made of liquid crystal. The liquid crystal lens is a lens having a refractive power that varies as an applied voltage is changed. The image-capturing unit 10x having the microlenses 104 having a refractive power of 1 outputs light-receiving signals similar to that of a normal camera. These light-receiving signals cannot create distance data. However, image data having a higher resolution than that of the image data created from light-receiving signals of the image-capturing unit 10a and the image-capturing unit 10b can be created, because this configuration differs from a configuration in which one pixel is generated for one microlens 104 as in the case of the image data created from light-receiving signals of the image-capturing unit 10a and the image-capturing unit 10b. For example, until the subject of interest is detected, the image-capturing unit 10x is used to create distance data or to create distance data by a combination of a plurality of image-capturing units, in a similar manner to the image-capturing units 10a, 10b. After detecting the subject of interest, the refractive power of the microlens 104 of the image-capturing unit 10x is set to 1 so that the image-capturing unit 10x is used only for obtaining image data of the subject of interest. In this way, image data having a higher resolution can be obtained for a subject of interest. Furthermore, for all image-capturing units, the refractive power of the microlens 104 may be variable.

Additionally, the microlens array 102 is not necessarily provided in the image-capturing unit 10x. In this case, the image-capturing unit 10x is used only for obtaining image data of the subject of interest. In this way, image data having a higher resolution can be obtained for a subject of interest.

Note that a light-receiving element having a light-receiving sensitivity not only for visible light, but also for infrared light or ultraviolet light may be used as the light-receiving element of the image-capturing unit in each embodiment. Thus, a light-receiving element having a light-receiving sensitivity to light other than visible light as described above is used to capture images by illuminating subjects such as persons and animals with infrared light or ultraviolet light at night and the like, so that images of persons and animals can be captured without their awareness of the illuminating light. Thus, this is particularly effective as a surveillance camera.

Modification

Note that an image-capturing system may be configured by installing a plurality of image-capturing devices 100 of each embodiment. For example, the image-capturing system has two image-capturing devices 100 of the first embodiment, and the first image-capturing device 100 and the second image-capturing device 100 are arranged to capture images of the same subject. The number of light-receiving elements of the image-capturing unit 10 of the first image-capturing device 100 is set smaller than the number of light-receiving elements of the image-capturing unit of the second image-capturing device, and the first image-capturing device is used for real time display and the second image-capturing device is used for recording. The first image-capturing device has a small number of image-capturing elements and thus a time required for processes such as computation in performing refocus process and ranging process is reduced. The first image-capturing device is therefore suitable for real time display. The second image-capturing device has a large number of image-capturing elements and thus a time required for processes such as calculation for refocus process and ranging process is increased. The second image-capturing device can therefore perform refocus process of a high-quality image and ranging process having a high accuracy with a long period of time, after recording the light-receiving signals in a recording unit.

Note that the number of microlenses of the image-capturing unit of the first image-capturing device may be smaller than the number of the microlenses of the image-capturing unit of the second image-capturing device. As the first image-capturing device has a smaller number of image-capturing elements, a time required for processes such as computation in performing refocus process and ranging process is reduced. The first image-capturing device is therefore suitable for real time display.

The disclosure of the following priority application is herein incorporated by reference:

Japanese Patent Application No. 2016-194628 (filed Sep. 30, 2016)

### REFERENCE SIGNS LIST

1, 1001 . . . image-capturing device, 10, 10a, 10b, 10c . . . image-capturing unit, 11 . . . control unit, 12 . . . display unit, 13 . . . storage unit, 101 . . . image-capturing optical system, 102 . . . microlens array, 103 . . . light-receiving element array, 104 . . . microlens, 105 . . . light-receiving element group, 106 . . . light-receiving element

1. An image-capturing device, comprising:
a first image-capturing unit and a second image-capturing unit, each of the first image-capturing unit and the second image-capturing unit having a plurality of lenses and a plurality of light-receiving units, each lens having a plurality of light-receiving units, the first image-capturing unit and the second image-capturing unit each outputting signals upon receiving light in the light-receiving units from a subject having transmitted through an image-capturing optical system via the plurality of lenses; and
a generation unit that generates images of the subject at a plurality of positions in an optical axis direction of the image-capturing optical system, based on a signal outputted from the first image-capturing unit and a signal outputted from the second image-capturing unit.

2. The image-capturing device according to claim 1, wherein:
the generation unit generates images of a first subject at a plurality of positions in the optical axis direction of the image-capturing optical system, based on a signal outputted from the light-receiving unit of the first image-capturing unit into which light from the first subject among the subject is incident and a signal outputted from the light-receiving unit of the second image-capturing unit into which the light from the first subject is incident.

3. The image-capturing device according to claim 2, wherein:
the generation unit generates images of the first subject at a plurality of positions in the optical axis direction of the image-capturing optical system, based on the signal outputted from the first image-capturing unit, if the light from the first subject is received by the light-receiving units of the first image-capturing unit and is not received by the light-receiving units of the second image-capturing unit.

4. The image-capturing device according to claim 2, wherein:
the generation unit generates images of the first subject at a plurality of positions in the optical axis direction of the image-capturing optical system, based on signals outputted from a light-receiving unit of a first lens and from a light-receiving unit of a second lens among the plurality of lenses of the first image-capturing unit into which light from the first subject is incident, and signals outputted from a light-receiving unit of a third lens and from a light-receiving unit of a fourth lens among the plurality of lenses of the second image-capturing unit into which light from the first subject is incident

5. The image-capturing device according to claim 4, wherein:
the generation unit generates images of the first subject based on the signals outputted from the first image-capturing unit and the signal outputted from the second image-capturing unit, if the images of the first subject cannot be generated at a plurality of positions spaced at smaller intervals than predetermined intervals in the optical axis direction of the image-capturing optical system by the signal outputted from the first image-capturing unit.

6. The image-capturing device according to claim 4, wherein:
a part of a range in which an image-capturing range where light is incident into the first image-capturing unit and an image-capturing range where light is incident into the second image-capturing unit overlap each other is within a distance from the image-capturing device within which images of the first subject can be generated by the generation unit at a plurality of positions spaced at smaller intervals than predetermined intervals in the optical axis direction of the image-capturing optical system based on the signal outputted from the first image-capturing unit.

7. The image-capturing device according to claim 6, further comprising:
a third image-capturing unit having a plurality of lenses and a plurality of light-receiving units, each lens having a plurality of light-receiving units, the third image-capturing unit outputting signals upon receiving light from a subject having transmitted through an image-capturing optical system in the light-receiving units, wherein:
a part of a range in which an image-capturing range where light is incident into the second image-capturing unit and an image-capturing range where light is incident into the third image-capturing unit overlap each other is within a distance from the image-capturing device within which images of the first subject can be generated by the generation unit at a plurality of positions spaced at smaller intervals than predetermined intervals in the optical axis direction of the image-capturing optical system based on the signal outputted from the first image-capturing unit.

8. The image-capturing device according to claim 4, comprising:
a detection unit that detects the first subject among the subject based on a signal outputted from the first image-capturing unit and a signal outputted from the second image-capturing unit.

9. (canceled)

10. (canceled)

11. (canceled)

12. (canceled)

13. (canceled)

14. (canceled)

15. (canceled)

16. The image-capturing device according to claim 4, comprising:
a third image-capturing unit having a plurality of lenses and a plurality of light-receiving units, each lens having a plurality of light-receiving units, the third image-capturing unit outputting a signal upon receiving light in the light-receiving units from a subject having transmitted through an image-capturing optical system including a lens having a variable focal length; and
a lens control unit that controls to change a focal length of the lens according to a size of the first subject, wherein:
the generation unit generates images of the subject at a plurality of positions in an optical axis direction of the image-capturing optical system, based on the signal outputted from the third image-capturing unit.

17. The image-capturing device according to claim 16, comprising:
a drive unit capable of changing an image-capturing direction of the third image-capturing unit; and
a drive control unit that controls the drive unit capable of changing the image-capturing direction in order to capture an image of the first subject.

18. An image-capturing device, comprising:
a first image-capturing unit including a plurality of image-capturing units each having an image-capturing optical system through which light from a subject transmits, the first image-capturing unit capturing an image of a subject to output a signal;
a second image-capturing unit including a plurality of image-capturing units each having an image-capturing optical system through which light from a subject transmits, the second image-capturing unit capturing an image of a subject to output a signal; and
a generation unit that generates an image of a subject at a plurality of positions in an optical axis direction of the image-capturing optical system, based on the signal outputted from the first image-capturing unit and the signal outputted from the second image-capturing unit.

19. The image-capturing device according to claim 18, wherein:
the generation unit generates images of a first subject at a plurality of positions in an optical axis direction of the image-capturing optical system, based on a signal outputted from the image-capturing unit of the first image-capturing unit capturing the first subject among the subject, and a signal outputted from the image-capturing unit of the second image-capturing unit capturing the first subject.

20. The image-capturing device according to claim 19, wherein:
the generation unit generates images of the first subject at a plurality of positions in the optical axis direction of the image-capturing optical system by performing a process on a first image generated by a signal from at least one of the image-capturing units included in the first image-capturing unit that captures an image of the first subject and a second image generated by a signal from at least one of the image-capturing units included in the first image-capturing unit that captures an image of the first subject.

21. The image-capturing device according to claim 20, wherein:
the generation unit performs, as the process, a process of combining the first image and the second image after deviating a position in a direction intersecting the optical axis of the image-capturing optical system of the first image and a position in a direction intersecting the optical axis of the image-capturing optical system of the second image with respect to each other.

22. (canceled)

23. (canceled)

24. The image-capturing device according to claim 1, wherein:
the light-receiving units have a light-receiving sensitivity for infrared light or ultraviolet light.

25. An image-capturing system, comprising:
a first image-capturing device having:
a first image-capturing unit having a plurality of lenses and a plurality of light-receiving units, each lens having a plurality of light-receiving units, the first image-capturing unit outputting a signal upon receiving light from a subject having transmitted through an image-capturing optical system in the light-receiving units;
a second image-capturing unit having a plurality of lenses and a plurality of light-receiving units, each lens having a plurality of light-receiving units, the second image-capturing unit outputting a signal upon receiving light from a subject having transmitted through an image-capturing optical system in the light-receiving units; and
a generation unit that generates images of the subject at a plurality of positions in an optical axis direction of the image-capturing optical system, based on the signal outputted from the first image-capturing unit and the signal outputted from the second image-capturing unit; and
a second image-capturing device having:
a third image-capturing unit having a plurality of lenses and a plurality of light-receiving units, each lens having a plurality of light-receiving units, the third image-capturing unit outputting a signal upon receiving light from a subject having transmitted through an image-capturing optical system in the light-receiving units;
a fourth image-capturing unit having a plurality of lenses and a plurality of light-receiving units, each lens having a plurality of light-receiving units, the fourth image-capturing unit outputting a signal upon receiving light from a subject having transmitted through an image-capturing optical system in the light-receiving units; and
a generation unit that generates images of the subject at a plurality of positions in an optical axis direction of the image-capturing optical system, based on the signal outputted from the third image-capturing unit and the signal outputted from the fourth image-capturing unit, wherein:
the number of light-receiving units provided for each of the lenses of the first image-capturing unit and the number of light-receiving units provided for each of the lenses of the second image-capturing unit are larger than the number of light-receiving units provided for each of the lenses of the third image-capturing unit and the number of light-receiving units provided for each of the lenses of the fourth image-capturing unit.

26. (canceled)

27. (canceled)

28. An image-capturing device, comprising:
a first image-capturing unit having a plurality of lenses and a plurality of light-receiving units, each lens having a plurality of light-receiving units, the first image-capturing unit outputting a signal upon receiving light from a subject having transmitted through an image-capturing optical system via the plurality of lenses in the light-receiving units;
a second image-capturing unit having a plurality of light-receiving units and outputting a signal upon receiving light from a subject having transmitted through an image-capturing optical system in the light-receiving units; and
a generation unit that generates images of the subject at a plurality of positions in an optical axis direction of the image-capturing optical system, based on the signal outputted from the first image-capturing unit and the signal outputted from the second image-capturing unit.
